(19) United States
(12) Patent Application Publication
(10) Pub. No.: US 2011/0117848 A1
(43) Pub. Date: May 19, 2011

(54) WIRELESS COMMUNICATION TERMINAL AND WIRELESS COMMUNICATION SYSTEM

(75) Inventor: Kenichi Tanaka, Osaka (JP)

(73) Assignee: KYOCERA CORPORATION, Kyoto-shi, Kyoto (JP)

(21) Appl. No.: 13/001,015

(22) PCT Filed: Mar. 26, 2009
(86) PCT No.: PCT/JP2009/001378

§ 371 Date: Dec. 22, 2010

(30) Foreign Application Priority Data
Jun. 26, 2008 (JP) 2008-167735 2008

(51) Int. Cl. H04B 7/00

(52) U.S. Cl. 455/41.2

(57) ABSTRACT

A mobile phone 10 transmits a notification request to a PDA (100c) among four PDAs (100a-100d) that have not established a connection to the mobile phone 10. When receiving the notification request, the PDA (100c) makes a notification by flashing an LED lamp. When a user views the flash of the LED lamp, the user can find which PDA actually corresponds to an alternative displayed on a screen (30d) of the mobile phone 10. Therefore, the flash of the LED lamp can be utilized as information for identifying a party of a connection establishment.

### TECHNICAL FIELD

The present invention relates in particular to a user interface relating to wireless communication connection.

### BACKGROUND ART

In recent years, Bluetooth (registered trademark) has been widely used in information terminals and mobile devices as a wireless communication technology.

The following is an overview of a connection method using the Bluetooth: (i) a master (terminal that transmits connection establishment request) searches for a slave (terminal that receives the connection establishment request) that can be connected; (ii) the master displays a list of the slaves searched for such that a user can select one of the slaves, and; (iii) the master transmits a connection request to the selected slave and then establishes the connection.

According to the Bluetooth, communication is possible in a range of 10-100 meters and accordingly more than one slave can be found by the search performed by the master. Therefore, as the number of the found slaves increases, a user's work load increases in selecting one of the slaves to which the user desires to connect.

With respect to this, conventionally, there has been a method for acquiring a nickname of each terminal and displaying each nickname on a list as above, so as to facilitate selection of connection destination.

### SUMMARY OF INVENTION

### Technical Problem

However, actually, a user might not set a nickname of each slave in many cases.

In this case, for example, a terminal model number has been often set as a default setting nickname by a manufacturer. When the terminal model number is displayed on a list as above, it is difficult especially for a user who is unfamiliar with the model number to select a terminal, since the model number looks like a meaningless character string to the user.

Also, when more than one slave has the same nickname and such a nickname is displayed on the list as above, it is useless as information for identifying a terminal.

Such a problem occurs not only in communication using the Bluetooth but also in wireless communication using another method.

The present invention has been achieved in view of the above problems, and aims to provide a wireless communication terminal and a wireless communication system that, in wireless communication connection, allows a user to easily identify one of found terminals which have not been connected yet.

### Solution to Problem

The wireless communication terminal of the present invention comprises: a communication unit operable to perform wireless communication; a search unit operable to search for one or more other wireless communication terminals for wireless communication performed by the communication unit; a display unit operable to display one or more items that each indicate a corresponding one of the one or more other wireless communication terminals searched for by the search unit; a first selection receiving unit operable to receive, from a user, selection of at least one of the one or more items displayed on the display unit; a notification request generating unit operable, when the first selection receiving unit receives the at least one selected item, to generate notification request information for requesting at least one of the one or more other wireless communication terminals indicated by the at least one selected item to make a notification to the user; and a transmission control unit operable to cause the communication unit to transmit the notification request information generated by the notification request generating unit to the at least one of the one or more other wireless communication terminals.

### Advantageous Effects of Invention

According to the wireless communication terminal of the present invention, the notification request generating unit generates the notification request information for notifying the user of the notification unit that is included in the at least one of the one or more other wireless communication terminals, which is indicated by the at least one selected item. The transmission control unit transmit the generated notification request information to the at least one of the one or more wireless communication terminals indicated by the at least one selected item, and accordingly it is possible for the at least one of the one or more other wireless communication terminals, which is a transmission destination, to make a notification to the user. It is therefore possible to notify the user of which terminal is actually a terminal that corresponds to the at least one selected item.

### BRIEF DESCRIPTION OF DRAWINGS

FIG. 1 shows a configuration of a wireless communication system 1 of an embodiment.

FIG. 2 is a functional block diagram of a mobile phone 10.

FIG. 3 is a functional block diagram of a PDA 100a.

FIG. 4 shows a data structure of an address table 19.

FIG. 5 is a flowchart showing an operation of the mobile phone 10 (master).

FIG. 6 is a flowchart showing an operation of PDAs 100a-100d (slave).

FIG. 7 is a sequence diagram showing an operational flow among the mobile phone 10 (master) and the PDAs 100a-100d (slave).

FIG. 8 shows a flow of establishment of a connection between the mobile phone 10 and the PDA 100c.

FIG. 9 shows a flow of establishment of a connection between the mobile phone 10 and the PDA 100c.

FIG. 10 shows a screen 40 of the mobile phone 10.

In FIG. 11A shows notification by vibration of the PDA 100c, and (b) shows notification by screen display of the PDA 100a and a screen 50 of the mobile phone 10.

FIG. 12 shows a screen 60 of the mobile phone 10.

FIG. 13 shows a screen 70 of the mobile phone 10 or the like.

FIG. 14 shows a screen 80 of the mobile phone 10 and the four PDAs 100a-100d.

### REFERENCE SIGNS LIST

1 wireless communication system
10 mobile phone (master)
14 operation input unit
16 display unit
20 wireless communication unit
22 inquiry unit
24 name acquisition unit
26 notification request transmission unit
30a-30e, 40, 50, 60, 70, 80 screens of mobile phone
100a-100d PDAs (slaves)
102 LED lamp
104 vibrator
106 operation input unit
108 display unit
110 wireless communication unit
112 inquiry response unit
114 name acquisition response unit
116 notification request response unit
120 speaker

### DESCRIPTION OF EMBODIMENTS

### Embodiment

### <Configuration>

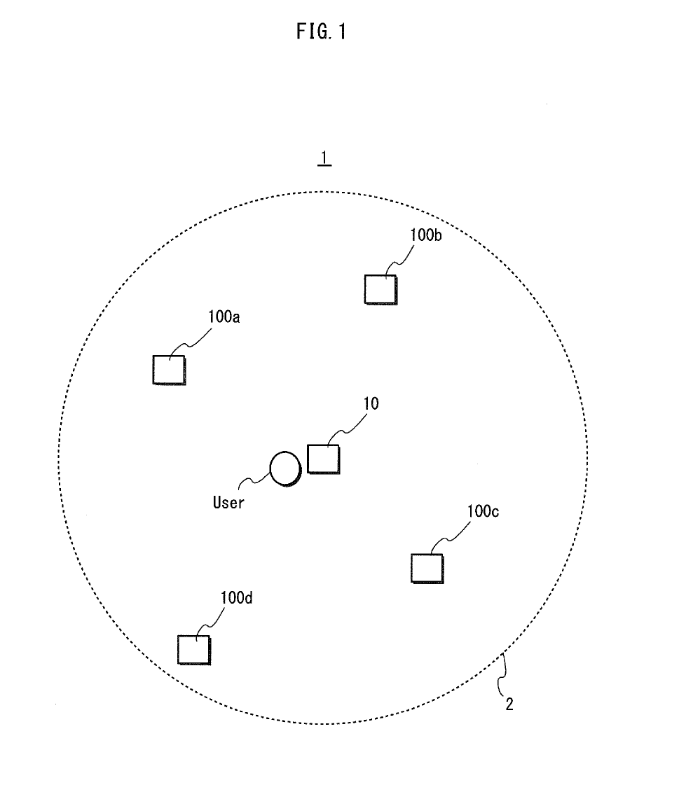

FIG. 1 shows a configuration of a wireless communication system of a present embodiment.

As FIG. 1 shows, the wireless communication system 1 includes mobile phone 10 and four PDAs (Personal Digital Assistants) 100a-100d.

The mobile phone 10 and the PDAs 100a-100d each include a wireless communication function compliant with the Bluetooth (registered trademark) standard.

The following explanation is based on the assumption that the mobile phone 10 is a master that transmits a connection establishment request and the PDAs 100a-100d are each a slave that receives the connection establishment request.

In FIG. 1, a circular area 2 shows the reach of a wireless Bluetooth signal transmitted by the mobile phone 10, and its radius is approximately 10 meters (output class: Class 2).

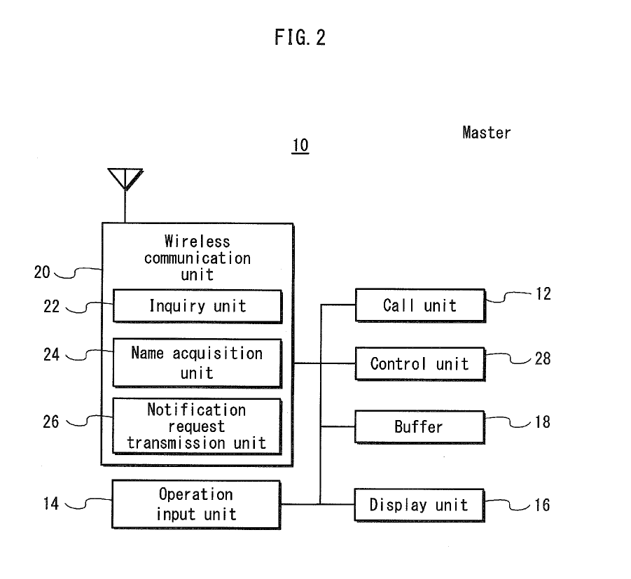

FIG. 2 is a functional block diagram of the mobile phone 10.

The mobile phone 10 includes a call unit 12, an operation input unit 14, a display unit 16, a buffer 18, a wireless communication unit 20 and a control unit 28.

The call unit 12 includes components that are generally mounted on a mobile phone, such as a communication circuit, and realizes a call function.

The operation input unit 14 includes operation keys as hardware, receives an input from a user, and transmits a signal indicating received content to the control unit 28. The operation keys are included in a general mobile phone, and include a numeric keypad, cursor keys (for moving a cursor in left, right, up, and down directions to select among alternatives) and an enter key (for determining the selection).

The display unit 16 includes a display, and performs various displays in accordance with display control signals transmitted by the control unit 28.

The buffer 18 includes components such as a RAM, temporarily stores therein various pieces of information acquired by the wireless communication unit 20 for displaying the stored pieces of information on the display unit 16.

The wireless communication unit 20 is a functional block that realizes a communication function compliant with the Bluetooth standard. The wireless communication unit 20 includes an inquiry unit 22, a name acquisition unit 24 and a notification request transmission unit 26. The wireless communication unit 20 searches for slaves that exist in a surrounding area of the mobile phone 10, and establishes a connection by transmitting a connection establishment request to one of the searched slaves. In addition, connection establishment between two terminals is referred to as “pairing”.

According to Bluetooth communication, when two terminals are in a connect state where they are simply connected to each other, a data packet transmission/reception is in principle not performed. The connection establishment means that two terminals in the connect state shifts to a Data Transfer state where the transmission/reception of the data packet is permitted.

The inquiry unit 22 broadcasts a signal (IQ packet) that indicates Inquiry.

The inquiry unit 22 then acquires a 48-bit address (Bluetooth Device Address) from a slave that has responded to the Inquiry.

The name acquisition unit 24 requests the responded slave for its nickname and acquires the nickname in accordance with a procedure (Name Discovery) standardized by the Bluetooth. The nickname is a name given to each slave.

The name acquisition unit 24 stores the nickname in the buffer 18 in association with the address acquired by the inquiry unit 22.

The notification request transmission unit 26 transmits a signal that indicates a notification request to the slave that is acquired by the operation input unit 14 and is a notification request destination. According to the present embodiment, the notification request transmission unit 26 transmits an L2CAP (Logical Link Control and Adaptation Protocol) Echo Request (L2CAP Ping) as the signal that indicates the notification request.

The control unit 28 includes hardware such as a CPU, a RAM and a ROM, and controls an operation of each compositional element by the CPU executing control programs stored in the ROM.

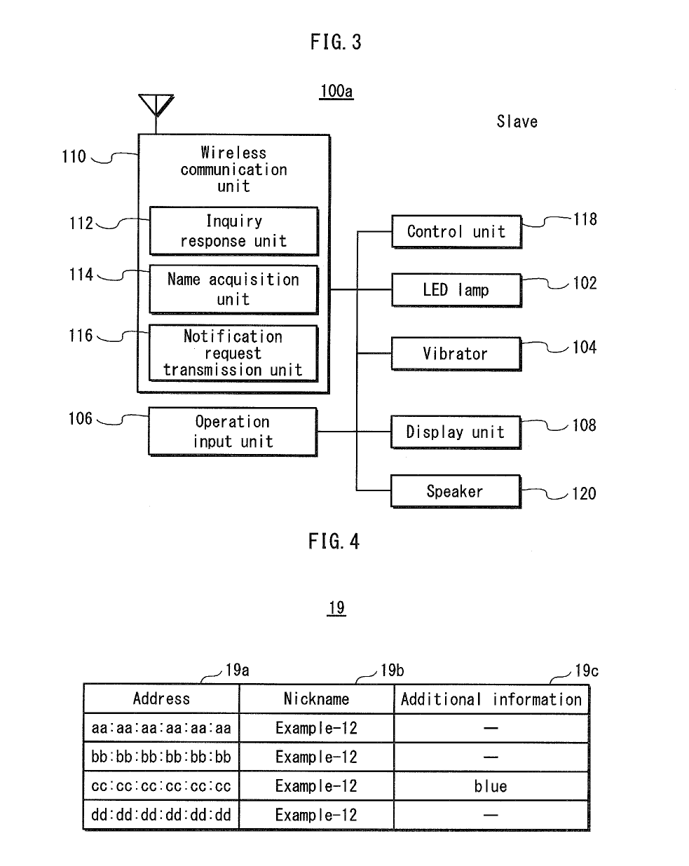

FIG. 3 is a functional block diagram of the PDA 100a. Since the PDAs 100a-100d have similar functional blocks, only the PDA 100a is explained as a representative.

The PDA 100a includes an LED lamp 102, a vibrator 104, an operation input unit 106, a display unit 108, a wireless communication unit 110, a control unit 118 and a speaker 120.

The LED lamp 102 includes a multiple-color LED, and flashes in accordance with a control signal transmitted by the control unit 118. The flashing informs of any event such as a telephone call, an e-mail arrival and a missed call.

The vibrator 104 vibrates in accordance with the control signal transmitted by the control unit 118. The vibrator 104 informs of the above incoming call by vibration.

The speaker 120 plays back an alarm sound or a melody in accordance with the control signal transmitted by the control unit 118.

The operation input unit 106 includes a touch screen that detects a touch with a stylus pen or a fingertip, receives an input from a user, and transmits a signal indicating the received content to the control unit 118.

The display unit 108 includes the above touch screen, and performs various displays in accordance with a display control signal transmitted by the control unit 118.

The wireless communication unit 110 includes an inquiry response unit 112, a name acquisition response unit 114 and a notification request response unit 116.

The inquiry response unit 112 scans an IQ packet transmitted by the inquiry unit 22 of the master in a connection wait state (Inquiry Scan). When receiving the IQ packet, the inquiry response unit 112 transmits an FHS (Frequency Hop Synchronization) packet as a response to the master. The FHS packet includes an address of the PDA 100a.

The name acquisition response unit 114 provides a nickname in accordance with an acquisition request from the name acquisition unit 24 of the master.

When receiving an L2CAP Echo Request that is a signal indicating a notification request, the notification request response unit 116 returns an L2CAP Echo Response that is a response to the reception. In addition, identification information for identifying the PDA 100a may be added to the L2CAP Echo Response. Details are described later.

Also, when receiving the L2CAP Echo Request, the notification request response unit 116 transmits a signal indicating a reception of the notification request to the control unit 118. When receiving the signal, the control unit 118 flashes the LED lamp 102 for a predetermined period (for example, 10 seconds).

FIG. 4 shows a data structure of the address table 19 stored in the buffer 18. In addition, cells of the address table 19 correspond one-to-one to the PDAs 100a-100d sequentially from the top.

The address table 19 includes items that are “address” 19a, “nickname” 19b and “additional information” 19c.

The “address” 19a is an address for identifying each slave.

The “nickname” 19b is a name given to each slave. A unique nickname has not been set for each of the four PDAs, and each nickname remains as their default model number “Example-12”. Since each nickname is the same, a user cannot identify the slaves.

The “additional information” 19c is additional information added to the L2CAP Echo Response transmitted by the notification request response unit 116 of the slave.

### <Operation>

The following describes operations performed in each terminal that constitutes the wireless communication system of the present embodiment, in reference with the drawings.

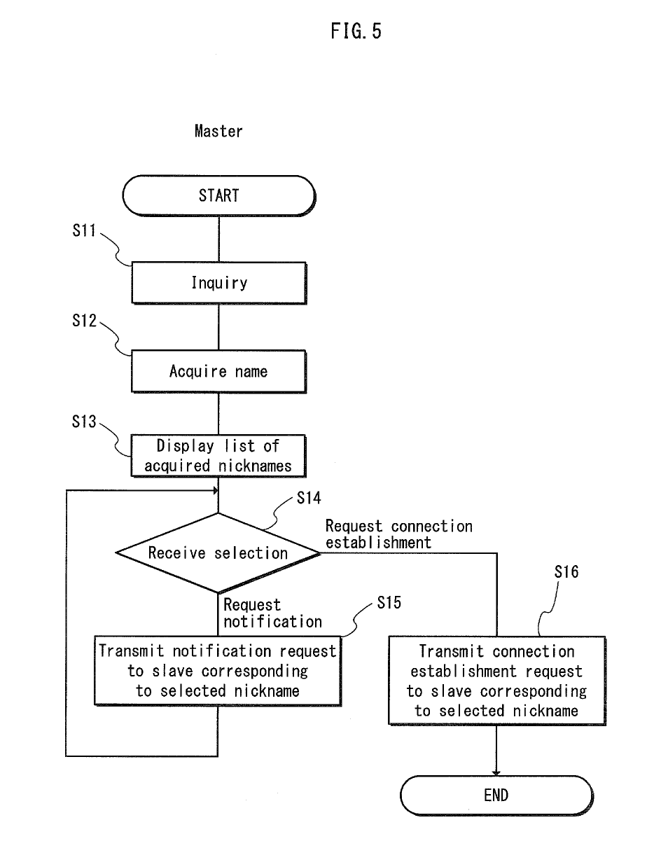

FIG. 5 is a flowchart showing an operation of the mobile phone 10 (master).

As FIG. 5 shows, the inquiry unit 22 of the mobile phone 10 transmits an IQ packet as an inquiry around the mobile phone 10, and receives an FHS packet that is a response to the inquiry (S11).

The wireless communication unit 20 of the mobile phone 10 identifies an address of each of the PDAs 100a-100d from addresses included in the received FHS packet. The name acquisition unit 24 transmits a name acquisition request to each of the PDAs 100a-100d whose addresses are identified, and acquires their nicknames (S12).

The control unit 28 of the mobile phone 10 displays a list of the four nicknames acquired from the PDAs 100a-100d. The nicknames of the PDAs 100a-100d are arranged in order on a screen of the display unit 16 (S13).

Then, the control unit 28 receives selection of the nickname displayed in the list via the operation input unit 14 (S14).

The selection includes “notification request” and “connection establishment request”.

The “notification request” is performed: for example, as follows: moving the cursor key of the operation input unit 14 up and down; selecting one of the four nicknames displayed sequentially from the top in S13; specifying the nickname that is in a selected state; and receiving the nickname as the notification request. Here, for example, the control unit 28 highlights the nickname in the selected state and displays on the display unit 16, so as to distinguish from other nicknames that have not been selected. When receiving the selection of the “notification request” (S14: “notification request”), the notification request transmission unit 26 acquires an address corresponding to the selected nickname by referencing the address table 19 stored in the buffer 18, identifies a slave that is a transmission destination, and transmits an L2CAP Echo Request that is a signal indicating the notification request to the slave (S15).

Also, when the control unit 28 receives the selection of the connection establishment request to one of the nicknames displayed in the list (S14: “Request connection establishment”), the wireless communication unit 20 transmits the connection establishment request to a slave corresponding to the selected nickname, and establishes the connection (S16).

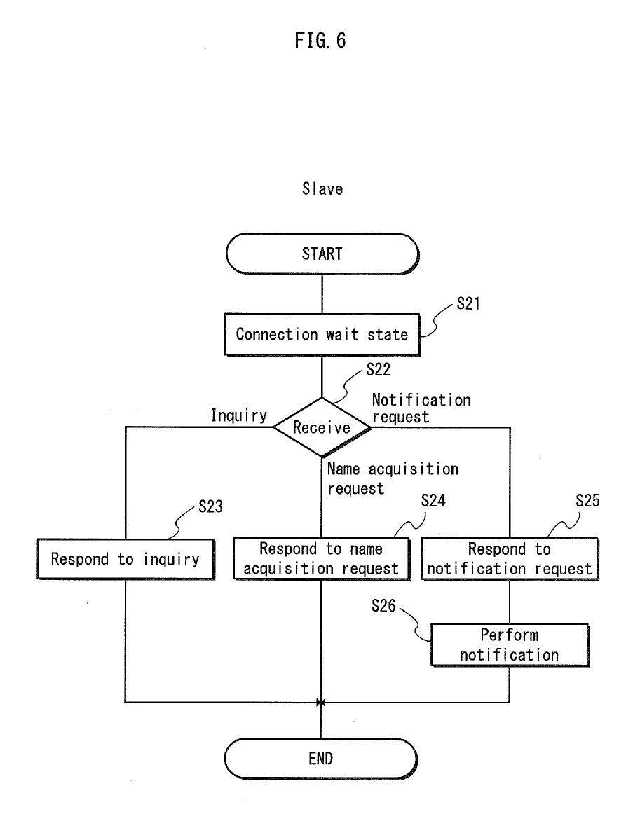

FIG. 6 is a flowchart showing an operation of the PDAs 100a-100d (slave). Since the four PDAs 100a-100d basically operate in the same way, they are collectively explained.

As FIG. 6 shows, the PDAs 100a-100d are each in a connection wait state (S21).

When receiving the IQ packet indicating an inquiry (S22: “Inquiry”), the inquiry response unit 112 of each of the PDAs 100a-100d returns an FHS packet to the mobile phone 10 in response to the IQ packet (S23).

When receiving a name acquisition request (S22: “Name acquisition request”), the name acquisition response unit 114 returns a nickname to the mobile phone 10 in response to the name acquisition request (S24).

When receiving an L2CAP Echo Request that indicates a notification request (S22: “Notification request”), the notification acquisition request unit 116 transmits the L2CAP Echo Response to the mobile phone 10 in response to the notification request (S25).

Then the control unit 118 makes a notification by flashing a predetermined notification unit, for example, the LED lamp 102 (S26).

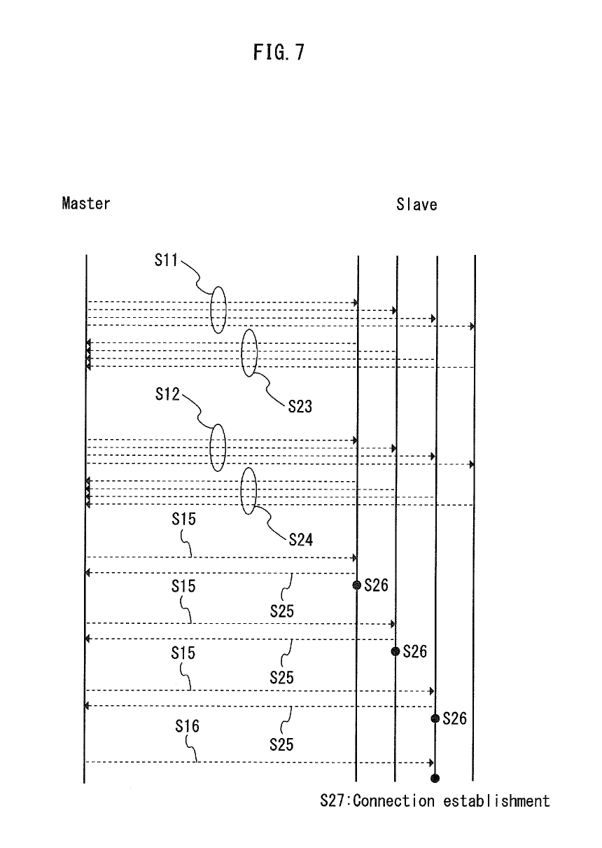

FIG. 7 is a sequence diagram showing an operational flow of the mobile phone 10 (master) and the PDAs 100a-100d (slave). When receiving a connection request from the master (S16), the slave establishes a connection to the master (S27).

Next, there is an explanation of an example of a specific operation viewed from a user interface side. The following explains aspects of the user interface in detail, and an explanation on internal operations of the terminals described above can be omitted.

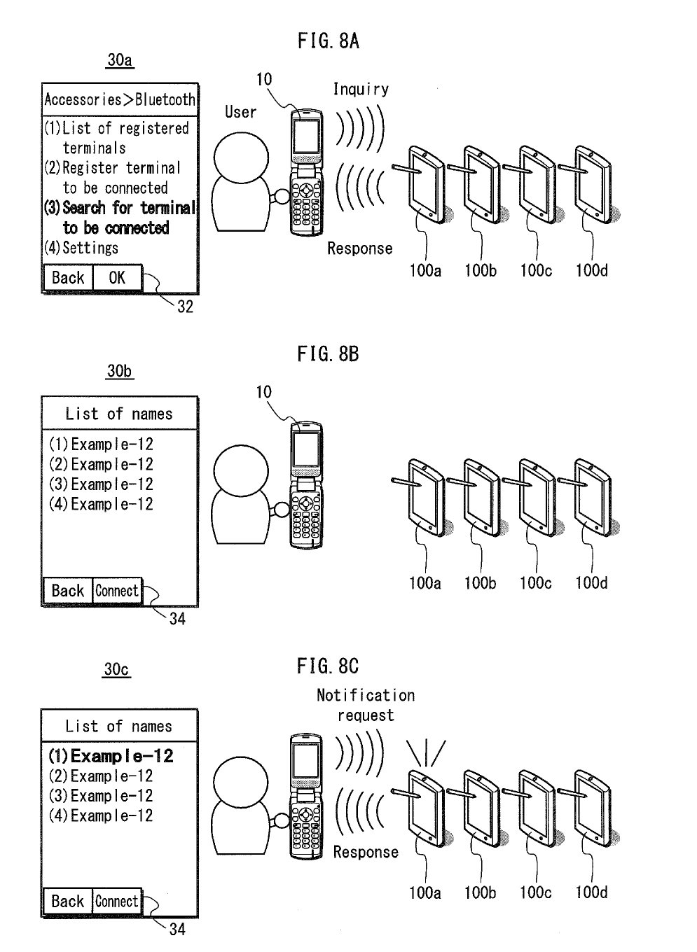

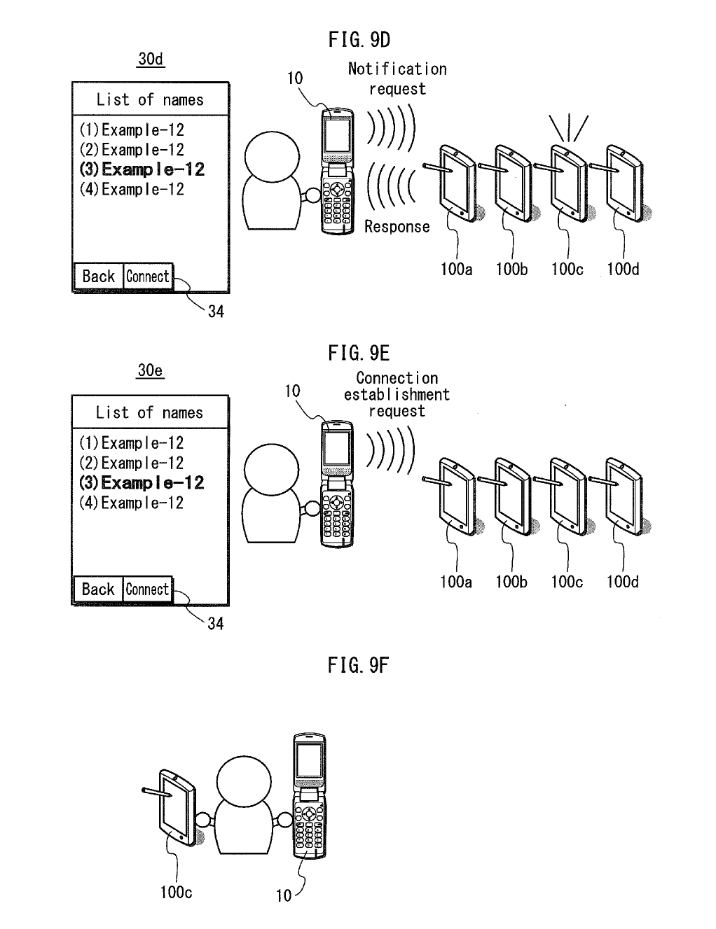

FIGS. 8A-8C and 9D-9F show a flow in which a user who desires to establish a Bluetooth connection between the mobile phone 10 and the PDA 100c searches for a slave that exists around the mobile phone 10, and establishes the desired connection. Screens 30a-30e are each a magnified view of the screen of the mobile phone 10.

First, as the screen 30a shows, the mobile phone 10 receives a user operation and calls a Bluetooth function. When the mobile phone 10 receives selection of an “OK” button 32 while an item “(3) Search for terminal to be connected” is selected, the slave that exists around the mobile phone 10 is searched for (FIG. 8A).

Then, the mobile phone 10 acquires a response that includes a nickname from each of the four slaves searched for, and displays a list of alternatives (1)-(4) that show the acquired four nicknames, as the screen 30b shows (FIG. 8B).

In addition, though it is not immediately obvious from the display, the explanation is based on the assumption that the alternatives (1)-(4) correspond to cells of the address table 19 (FIG. 4) sequentially from the top. For example, the alternative (1) corresponds to the PDA 100a and its address is “aa:aa:aa:aa:aa:aa:aa”.

In addition, on the screen 30b, when a “Connect” button 34 is selected while any one of the alternatives (1)-(4) is selected, the wireless communication unit 20 of the mobile phone 10 transmits a connection establishment request to the slave that corresponds to the selected nickname.

Since the four nicknames displayed on the screen 30b are the same “Example-12”, a user does not know which of the alternatives (1)-(4) displayed on the screen 30b actually corresponds to which of the PDAs 100a-100d.

Subsequently, as the screen 30c shows, when receiving selection of the alternative (1) included in the list of the nicknames, the notification request transmission unit 26 of the mobile phone 10 references the first row of the address table 19 stored in the buffer 18 and transmits the notification request to the PDA 100a that has the address “aa:aa:aa:aa:aa:aa:aa”. When receiving the notification request, the notification acquisition request unit 116 of the PDA 100a flashes the LED lamp (FIG. 8C).

On the screen 30c, the alternative (1) that is in a selected state is highlighted with boldface. Accordingly, when the user views the flashing LED lamp of the PDA 100a, the user can intuitively find that the flashing PDA 100a corresponds to the alternative (1) displayed on the screen 30c.

Subsequently, when receiving a move of the cursor key twice in a down direction, the mobile phone 10 changes the display so as to show the screen 30d in which the alternative (3) is in the selected state. The notification request transmission unit 26 of the mobile phone 10 then references the third row of the address table 19 stored in the buffer 18, transmits the notification request to the PDA 100c that has the address “cc:cc:cc:cc:cc:cc:”, and flashes the LED lamp (FIG. 9D).

After confirming that the LED lamp of the PDA 100c to which the user desires to connect to is flashing, the user selects the “Connect” button 34 while the alternative (3) is in the selected state. When receiving the selection, the wireless communication unit 20 of the mobile phone 10 transmits the connection establishment request to the PDA 100c that corresponds to the alternative (3) (FIG. 9F).

As a result of the transmission of the connection establishment request, the user has established the desired connection between the mobile phone 10 and the PDA 100c (FIG. 9F).

### <Supplementary Explanations>

Although the embodiment of the present invention has been described, the present invention is not limited to the above embodiment. The present invention can be implemented in various embodiments for achieving the aim of the present invention and an aim relating to the aim of the present invention. For example, the following may be employed.

1. According to Step S25 in the FIG. 6, the notification acquisition request unit 116 transmits the L2CAP Echo Response as a response. However, it may be possible to add information (such as a user name and color of a housing of the terminal) that helps to identify the terminal to the L2CAP Echo Response.

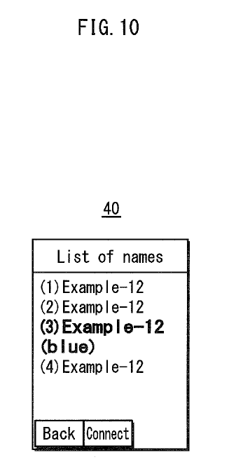

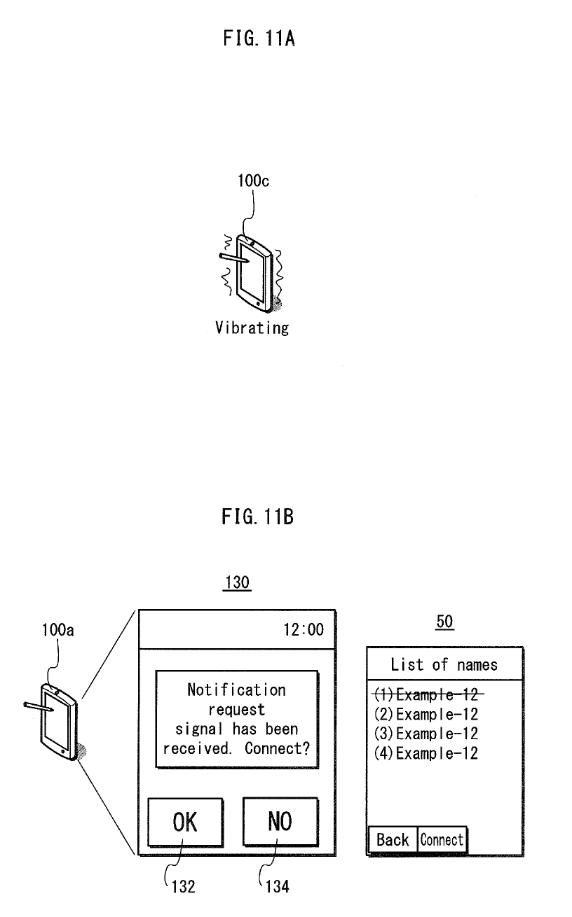

For example, when the color of the body of the PDA 100c is blue, the L2CAP Echo Response may have additional character information “Blue” and may be transmitted to the mobile phone 10 that is the master. The mobile phone 10 may then store the character “Blue” as additional information in the address table 19 stored in the buffer 18 for display. A display example is shown in FIG. 10. On the screen 40 of the mobile phone 10, a character “Blue” acquired from the PDA 100c is added to the alternative (3). Thus, by displaying the information acquired from the PDA 100c that has transmitted the notification request, information for the user to identify terminals can be increased.

When information is added to the L2CAP Echo Response, a field that is provided as an alternative for the L2CAP Echo Response is available. However, since an allowed data size of the field is limited, the L2CAP Echo Request/Response may be transmitted/received more than once when information with a large data size is added.

2. According to the embodiment, the flash of the LED lamp makes a notification. However, a notification method may be other methods, as long as a user (human) can experience those methods with his five senses. Specifically, sound, vibration or screen display may be used for notification. FIG. 11A shows an example in which vibration of the vibrator 104 of the PDA 100c makes a notification.

FIG. 11B shows an example of notification by screen display and a touch screen of the PDA 100a displays a dialogue screen (confirmation request screen) 130. The dialogue screen 130 displays a message indicating the notification request has been received and an “OK” key 132 and a “NO” key 134, which show whether the connection is possible or not.

Here, in the case where the PDA 100a receives the “NO” key 134, the PDA 100a transmits connection establishment impermissible information indicating that the connection establishment is impossible to the mobile phone 10. When receiving the connection establishment impermissible information, the mobile phone 10, as the screen 50 shows, makes the alternative (1) unselectable by applying strikethrough on the alternative (1). In addition, the alternative (1) may be deleted. With this configuration, it is possible to easily narrow down in phases the terminal that the user desires to connect to.

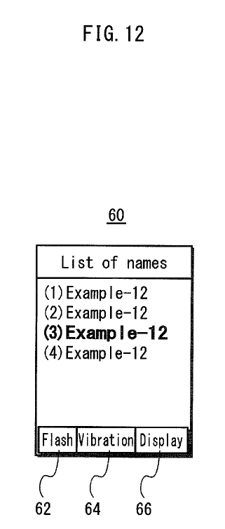

3. The mobile phone 10 may receive a specification of the notification method. As FIG. 12 shows, a “Flash” button 62, a “Vibration” button 64, and a “Display” button 66 that specify the notification method are displayed on the screen 60. When receiving selection of, for example, the “Vibration” button 64 while selecting, for example, the alternative (3), the mobile phone 10 transmits the notification request that includes notification method information indicating that the notification must be made by the “vibration”, to the PDA 100c that corresponds to the alternative (3). When receiving the notification request, the PDA 100c then makes a notification by the vibration. By this, a notification method that the user likes can be realized. Thus, it is possible to flexibly respond to the notification in the case where the user cannot easily recognize lighting or screen display, such as the case where the PDA 100c is put out of sight.

4. In order to increase variation of the notification, the notification request may be transmitted while specifying the notification conditions (such as a lighting time, interval of flash, and lighting color of the LED lamp, or time, pattern and strength of the vibration) that are to be included in the notification method. Also, the notification request having priority may be transmitted. For example, vibration is set to be in the first priority, and a flash is set to be in the second priority.

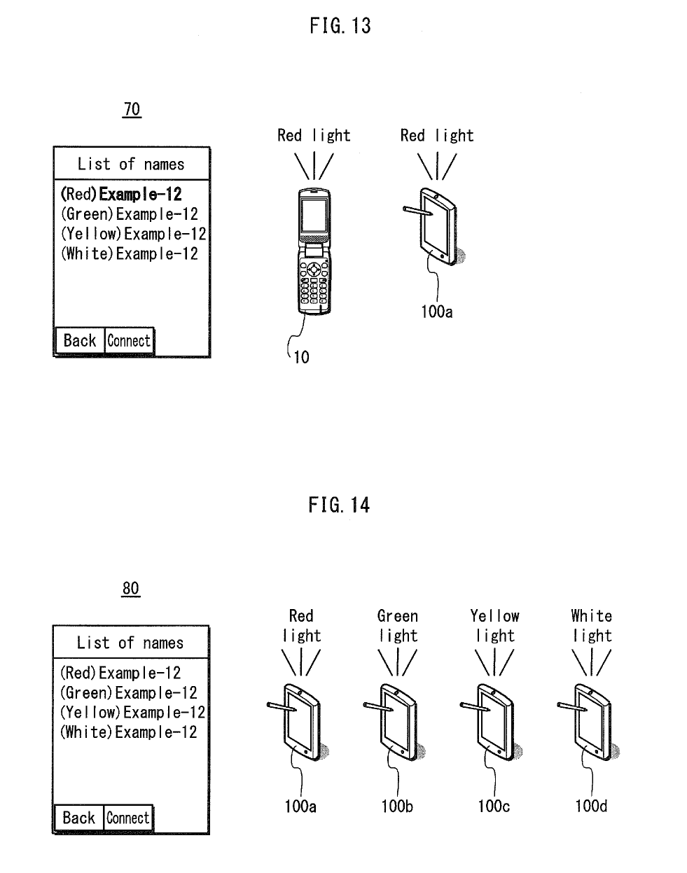

5. According to the embodiment, each notification method of the PDAs 100a-100d is the same. However, each slave may have a different notification method. That is, as FIG. 13 shows, the alternatives “Red”, “Green”, “Yellow” and “White” are displayed on the screen 70 of the mobile phone 10. Each alternative shows a color of the flashing LED. When the alternative “Red” is selected, the PDA 100a that corresponds to the alternative flashes red light. With this configuration, by comparing the colors “red”, “green”, “yellow” and “white” with the color of the LED that is actually flashing, a user is easily notified of which option on the screen 70 actually corresponds to which terminal.

Especially, by flashing the LED of the mobile phone 10 in red in synchronization with the flash of red light of the PDA 100a, the user can recognize at a glance a pair of terminals that are to establish pairing with each other.

Also, when a notification method of each terminal is different, there is little inconvenience even though notifications are made at the same time. Therefore, the user may make a notification without selecting the terminal to be notified. According to an example shown in the FIG. 14, colors of the flashing LED light are displayed on the screen 80 of the mobile phone 10 and each of the four PDAs 100a-100d flashes light of a different color of the LED at the same time.

6. According to the embodiment, as FIG. 8B shows, the nicknames are displayed on the screen 30b. However, other information instead of the nicknames may be displayed as alternatives.

That is, information that is displayed as the alternative has only to be unique (identifiable) information that corresponds to each terminal (PDAs 100a-100d). For example, the followings may be sufficient: information that each terminal has uniquely such as an address; and information that corresponds to each terminal and is stored in the address table such as additional information (FIG. 4). Also, instead of character, images that represent respective terminals, such as icons may be displayed as the alternative.

Furthermore, according to the embodiment, as FIG. 9 shows, the options are the four items. However, the options may be two items or one item.

For example, in the case where the number of terminals searched for is only one, only one item that corresponds to the terminal searched for may be displayed.

7. According to the embodiment, when the mobile phone 10 transmits the notification request, the slave that is the transmission destination is displayed on the screen of the mobile phone 10. However, the slave may not be displayed on the screen.

For example, when receiving numeric inputs of “1” to “3” from the numeric keypad that constitutes the operation input unit 14, the notification request may be transmitted to each of three slaves corresponding to the input numerals, respectively. In such a occasion, a user can judge a one-to-one correspondence relation between three slaves and numeric characters from “1” to “3” that have been input from the numeric keypad, by transmitting the notification method information that indicates notification with synthesized voice saying “one”, “two” and “three” to respective three slaves and is included in the notification request information.

### <Supplementary Explanations 2>

One aspect of the mobile phone pertaining to the present embodiment may be configured as follows.

1. The mobile phone may comprise: a communication unit operable to perform wireless communication; a search unit operable to search for one or more other wireless communication terminals for wireless communication performed by the communication unit; a display unit operable to display one or more items that each indicate a corresponding one of the one or more other wireless communication terminals searched for by the search unit; a first selection receiving unit operable to receive, from a user, selection of at least one of the one or more items displayed on the display unit; a notification request generating unit operable, when the first selection receiving unit receives the at least one selected item, to generate notification request information for requesting at least one of the one or more other wireless communication terminals indicated by the at least one selected item to make a notification to the user; and a transmission control unit operable to cause the communication unit to transmit the notification request information generated by the notification request generating unit to the at least one of the one or more other wireless communication terminals.
2. According to the configuration 1, the mobile phone may include a notification method display unit operable, when the first selection receiving unit receives the at least one selected item, to display a plurality of notification methods that are associated with the at least one of the one or more other wireless communication terminals; and a second selection receiving unit operable to receive, from the user, selection of at least one of the plurality of notification methods displayed on the notification method display unit, wherein the notification request generating unit may generate the notification request information based on the at least one selected notification method received by the second selection receiving unit.
3. According to the configuration 2, the notification methods may be each performed using at least one of sound, light, vibration or screen display.
4. According to the configuration 1, the mobile phone may include a connection unit operable, when the at least one item is selected, to attempt to establish a connection for the communication unit to perform wireless communication with the at least one of the one or more other wireless communication terminals indicated by the at least one selected item.

One aspect of a mobile phone system pertaining to the present embodiment may be configured as follows.

5. The mobile phone system may comprise a first wireless communication terminal and a plurality of second wireless communication terminals, wherein, the first wireless communication terminal includes: a search unit operable to search the plurality of second wireless communication terminals for one or more second wireless communication terminals for wireless communication; and a transmission unit operable to transmit notification request information for requesting the one or more second wireless communication terminals searched for by the search unit to make a notification to a user, and the plurality of second wireless communication terminals each include a notification unit operable, when the notification request information is received, to notify the user of the reception.

With this configuration, by causing the second wireless communication terminal, which is a transmission destination of the notification request information that indicates the notification request, to make notification to the user, the user can recognize which terminal is actually the second wireless communication terminal to which the notification request information has been transmitted. For example, it is possible to provide the user with information for selecting a terminal that is to establish a connection to the first wireless communication terminal.

6. According to the configuration 5, the first wireless communication terminal may further include: a display unit operable to display one or more items that each indicate a corresponding one of the one or more second wireless communication terminals searched for by the search unit; and a receiving unit operable to receive, from the user, selection of at least one of the one or more items displayed on the display unit, and the transmission unit performs the transmission to at least one of the one or more second wireless communication terminals indicated by the at least one selected item received by the receiving unit.
7. According to the configuration 6, the plurality of second wireless communication terminals each may include a display unit operable to perform a display, the notification unit makes the notification by causing the display unit of the second wireless communication terminal to display a screen that (i) indicates that the notification request information has been received from the first wireless communication terminal and (ii) receives, from the user, selection of whether connection establishment to the first wireless communication terminal is permitted, the plurality of second wireless communication terminals each may include a transmission unit operable, when selection indicating that the connection establishment is not permitted is received, to transmit connection establishment impermissible information that indicates that communication is not permitted to the first wireless communication terminal, and when the first wireless communication terminal receives the connection establishment impermissible information, the display unit of the first wireless communication terminal may change display such that the at least one selected item, which indicates the second wireless communication terminal that has transmitted the connection establishment impermissible information, is unselectable.
8. According to the configuration 6, mobile phone system may include a connection unit operable, when the at least one item is selected, to attempt to establish a wireless communication connection with the at least one second wireless communication terminal indicated by the at least one selected item.
9. According to the configuration 6, the plurality of second wireless communication terminals each may include an identification information transmission unit operable, when the notification request information is received, to transmit identification information for identifying the second wireless communication terminal to the first wireless communication terminal, and when the first wireless communication terminal receives the identification information, the display unit may display in detail, based on the received identification information, the at least one selected item, which indicates the at least one second wireless communication terminal that has transmitted the identification information.
10. According to the configuration 6, the receiving unit may receive specification of notification methods that are associated with the at least one second wireless communication terminal, the notification request information may include notification method information that indicates the specified notification methods, and the notification unit may make the notification with use of the notification methods indicated by the notification method information.
11. According to the configuration 10, the notification methods may be performed using at least one of sound, light, vibration or screen display.
12. According to the configuration 5, the notification request information transmitted by the transmission unit may include notification method information that indicates a notification method, and the first wireless communication terminal further includes a display unit operable to (i) indicate the one or more second wireless communication terminals searched for by the search unit, and (ii) display an item that indicates the notification method indicated by the notification method information included in the notification request information transmitted by the transmission unit.

### INDUSTRIAL APPLICABILITY

The wireless communication terminal of the present invention is useful in facilitating a user interface when the terminals establish pairing with each other.

1. A wireless communication terminal comprising:
a communication unit operable to perform wireless communication;
a search unit operable to search for one or more other wireless communication terminals for wireless communication performed by the communication unit;
a display unit operable to display one or more items that each indicate a corresponding one of the one or more other wireless communication terminals searched for by the search unit;
a first selection receiving unit operable to receive, from a user, selection of at least one of the one or more items displayed on the display unit;
a notification request generating unit operable, when the first selection receiving unit receives the at least one selected item, to generate notification request information for requesting at least one of the one or more other wireless communication terminals indicated by the at least one selected item to make a notification to the user; and
a transmission control unit operable to cause the communication unit to transmit the notification request information generated by the notification request generating unit to the at least one of the one or more other wireless communication terminals.

2. The wireless communication terminal of claim 1, further comprising:
a notification method display unit operable, when the first selection receiving unit receives the at least one selected item, to display a plurality of notification methods that are associated with the at least one of the one or more other wireless communication terminals; and
a second selection receiving unit operable to receive, from the user, selection of at least one of the plurality of notification methods displayed on the notification method display unit, wherein
the notification request generating unit generates the notification request information based on the at least one selected notification method received by the second selection receiving unit.

3. The wireless communication terminal of claim 2, wherein
the notification methods are each performed using at least one of sound, light, vibration or screen display.

4. The wireless communication terminal of claim 1, further comprising
a connection unit operable, when the at least one item is selected, to attempt to establish a connection for the communication unit to perform wireless communication with the at least one of the one or more other wireless communication terminals indicated by the at least one selected item.

5. A wireless communication system comprising:
a first wireless communication terminal and a plurality of second wireless communication terminals, wherein,
the first wireless communication terminal includes:
a search unit operable to search the plurality of second wireless communication terminals for one or more second wireless communication terminals for wireless communication; and
a transmission unit operable to transmit notification request information for requesting the one or more second wireless communication terminals searched for by the search unit to make a notification to a user, and
the plurality of second wireless communication terminals each include a notification unit operable, when the notification request information is received, to notify the user of the reception.

6. The wireless communication system of claim 5, wherein
the first wireless communication terminal further includes:
a display unit operable to display one or more items that each indicate a corresponding one of the one or more second wireless communication terminals searched for by the search unit; and
a receiving unit operable to receive, from the user, selection of at least one of the one or more items displayed on the display unit, and
the transmission unit performs the transmission to at least one of the one or more second wireless communication terminals indicated by the at least one selected item received by the receiving unit.

7. The wireless communication system of claim 6, wherein
the plurality of second wireless communication terminals each include a display unit operable to perform a display,
the notification unit makes the notification by causing the display unit of the second wireless communication terminal to display a screen that (i) indicates that the notification request information has been received from the first wireless communication terminal and (ii) receives, from the user, selection of whether connection establishment to the first wireless communication terminal is permitted,
the plurality of second wireless communication terminals each include a transmission unit operable, when selection indicating that the connection establishment is not permitted is received, to transmit connection establishment impermissible information that indicates that communication is not permitted to the first wireless communication terminal, and
when the first wireless communication terminal receives the connection establishment impermissible information, the display unit of the first wireless communication terminal changes display such that the at least one selected item, which indicates the second wireless communication terminal that has transmitted the connection establishment impermissible information, is unselectable.

8. The wireless communication system of claim 6, further comprising
a connection unit operable, when the at least one item is selected, to attempt to establish a wireless communication connection with the at least one second wireless communication terminal indicated by the at least one selected item.

9. The wireless communication system of claim 6, wherein
the plurality of second wireless communication terminals each include an identification information transmission unit operable, when the notification request information is received, to transmit identification information for identifying the second wireless communication terminal to the first wireless communication terminal, and
when the first wireless communication terminal receives the identification information, the display unit displays in detail, based on the received identification information, the at least one selected item, which indicates the at least one second wireless communication terminal that has transmitted the identification information.

10. The wireless communication system of claim 6, wherein
the receiving unit receives specification of notification methods that are associated with the at least one second wireless communication terminal,
the notification request information includes notification method information that indicates the specified notification methods, and
the notification unit makes the notification with use of the notification methods indicated by the notification method information.

11. The wireless communication system of claim 10, wherein
the notification methods are performed using at least one of sound, light, vibration or screen display.

12. The wireless communication system of claim 5, wherein
the notification request information transmitted by the transmission unit includes notification method information that indicates a notification method, and
the first wireless communication terminal further includes a display unit operable to (i) indicate the one or more second wireless communication terminals searched for by the search unit, and (ii) display an item that indicates the notification method indicated by the notification method information included in the notification request information transmitted by the transmission unit.
